(19) United States
(12) Patent Application Publication
(10) Pub. No.: US 2007/0156629 A1
(43) Pub. Date: Jul. 5, 2007

(54) Target context aware object-based navigation

(75) Inventor: Iija Fischer, Bad Schoenborn (DE)

Correspondence Address: KENYON & KENYON LLP, 1500 K STREET N.W., WASHINGTON, DC, 20005, US

(73) Assignee: SAP AG

(21) Appl. No.: 11/319,421

(22) Filed: Dec. 29, 2005

(51) Int. Cl. G06F 17/30

(52) U.S. Cl. 707/1

(57) ABSTRACT

The present invention provides methods and systems for allowing object-based navigation between business objects and applications where the displayed view of a target application is specific to the use context in which the user selects a navigation element. Context criteria on which the target view depends include the source business object, the user's role, and the source application.

### BACKGROUND

Object-based navigation (OBN) is a way of navigating between components of a complex system, such as a business management system. In such a system, a user accesses functions and components of the system via applications that display instances of business objects. As a specific example, an application provides a user access to an order management system, whereby selecting a field displayed in an instance of a business object, such as a customer, order, or contract, allows a user to view and manipulate information about that business object instance. By accessing an instance of a business object via an application, a user may manipulate information stored in a business object, for example by viewing and modifying outstanding orders within an instance of a sales orders business object.

FIG. 1 shows a navigation process in a system implementing object-based navigation. An application view 120, 140, or 160 may be a compilation of system information, business objects, and other related information. A view 120 of a source application 110 displays fields 121 and 122. These fields may be, for example, customer names, account numbers, or other information. Each field may be a business object instance. When a user selects a field 122, he navigates to a view 160 of a target application 150. A field displayed in an application may be an instance of a business object, or it may be part of the business object instance displayed by the application. In FIG. 1, a second source application 130 is shown with a second source view 120. The second application view 140 displays fields 141 and 122. The applications 110 and 130 may be the same applications, with the business objects shown in views 120 and 130 being different, or the applications 110 and 130 may be different applications and the business object instances shown in the views 120 and 140 instances of the same business object. Similarly, instances of different business objects may display some of the same fields. For example, in FIG. 1 the views 120 and 140 may both display the same field or business object instance 122.

When a user selects a field displayed in an application view, he navigates to a new application, business object, or both. In FIG. 1, when a user selects a field 122 in the first source application 110, he navigates to a target application 150 displaying a view 160. The target business object may also display fields 161, 162 allowing for further navigation. For example, selecting Field 6 (162) allows the user to display a different view of the target application 150. As shown in FIG. 1, a user will navigate to the same target application view 160 regardless of the context in which the field 122 linked to the target application 150 is selected. That is, the source applications 110 and 130 and views 120 and 140 may be very different applications or business objects semantically, but the same target application 150 and view 160 are displayed regardless. If a user wishes to display a different view 170 of the target application 150, he must select a field 162 in the target application in order to display the desired view.

As described above, when a user selects a field in an OBN application the user navigates to a view of a target application. The target application may have multiple views available. However, the user is directed to the same view of the target application regardless of the context in which the field was selected. Thus, two users with different roles in the system will always be directed to the same target application. Similarly, a user who selects a field in one application will be directed to the same target application when he selects the same field in a different source application. There is therefore a need for a system and method allowing for navigation to different views of an application in an OBN system based on the context in which a field is selected.

### BRIEF DESCRIPTION OF THE DRAWINGS

FIG. 1 is a block diagram illustrating object-based navigation between applications.

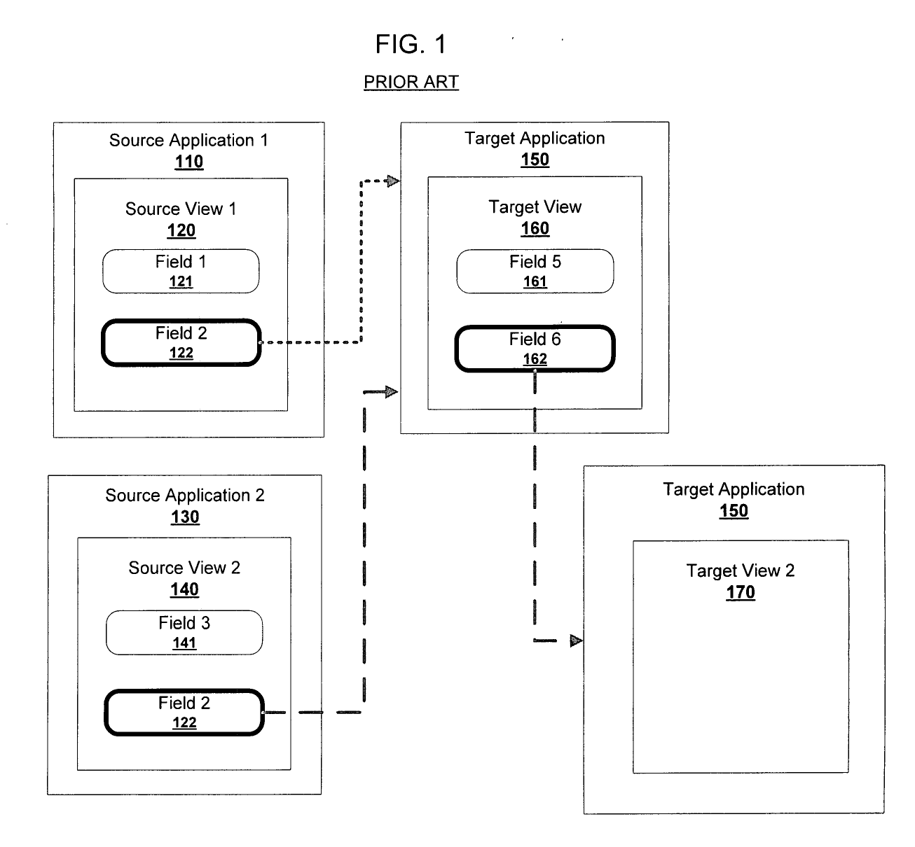

FIG. 2 is a block diagram illustrating object-based navigation between applications according to an embodiment of the invention.

FIG. 3 is a flowchart illustrating a navigation process according to an embodiment of the invention.

FIG. 4 is a block diagram illustrating object-based navigation between applications according to an embodiment of the invention.

FIG. 5 shows a system implementing object-based navigation according to an embodiment of the invention.

FIG. 6 shows an example system including object-based navigation according to an embodiment of the invention.

FIG. 7 is an example of a navigation according to an embodiment of the present invention.

### DETAILED DESCRIPTION

The present invention provides a method for allowing object-based navigation between business object instances where the view of a target application accessed by a user is specific to the source business object, user role, and source application used to access the target application.

An application such as a sales management application may display a business object instance having fields that a user can select to navigate to a target application using object-based navigation. The source (first) business object and/or application may be the same as the target business object and/or application, or it may be different. According to the present invention, the view of the target application displayed may be determined based on the source business object, the user's role, and the source application. An application view may contain business object instances, navigation elements, and other data or information.

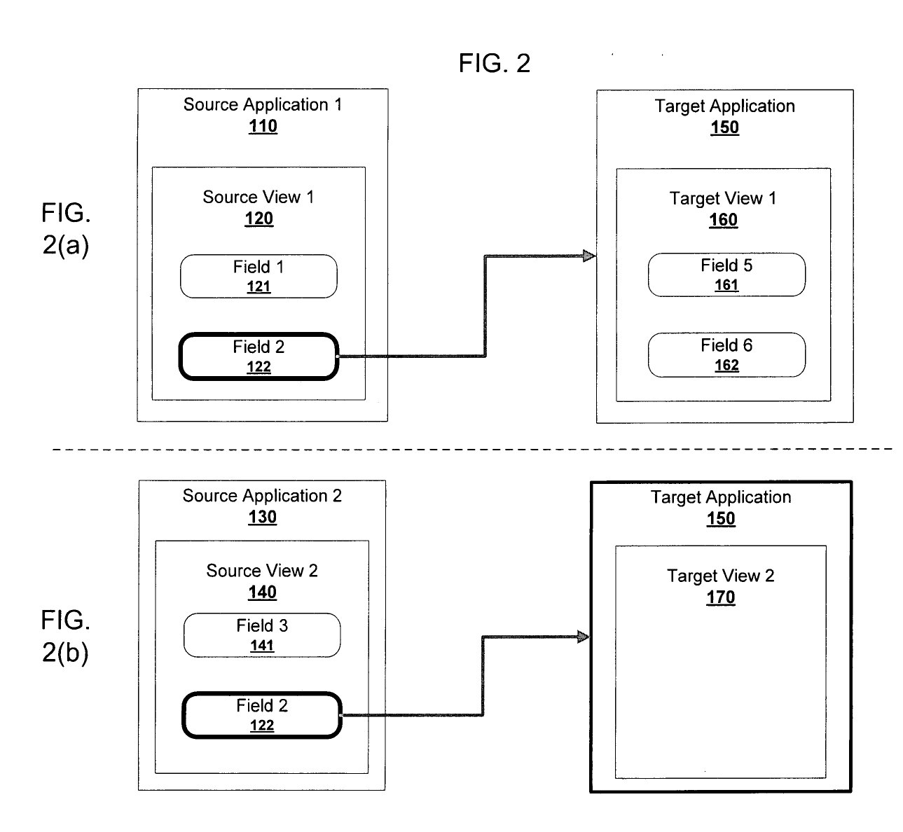

FIG. 2 shows an example of object-based navigation according to the present invention. A navigation where a user selects a navigation element 122 is shown in FIG. 2(a). A similar navigation, where the user selects the same navigation element 122 within a different source application and/or source view is shown in FIG. 2(b). The navigation elements may be hyperlinks displayed in a web page, instances of business objects, or any other appropriate field. A user who selects Field 2 (122) in a first source application 110 may be directed to a first target application 150 displaying a first target view 160. A user selecting the same field 122 in a second view 140 displayed in a second source application 130 may be directed to a different view 170 of the target application 150. The target view displayed may be based on relationships between the application 110 or 130 that the user was accessing when the field 122 was selected, the user's role in the system, and the business object instance containing or represented by the field used for navigation 122. Other contextual data may also be used to determine the target view. Thus, Source Application 1 (110) and Source Application 2 (130) may be the same application with Source View 1 (120) and Source View 2 (140) being different views. For example, the source applications 110 and 130 may both be a customer relations management application, with Source View 1 (120) displaying a customer's financial information, and Source View 2 (140) showing the customer's order history. Similarly, the source applications 110 and 130 may be different applications displaying different views 120 and 140. As an example, a user accessing a view 120 in a customer relations application 110 may be directed to a different target view 160 than the same user accessing a view 140 of the same business object from within a resource management application 130. The target application view 160 or 170 to which the user navigates may be pre-determined by a user or system developer to be the view most related to the source application and source view or business object.

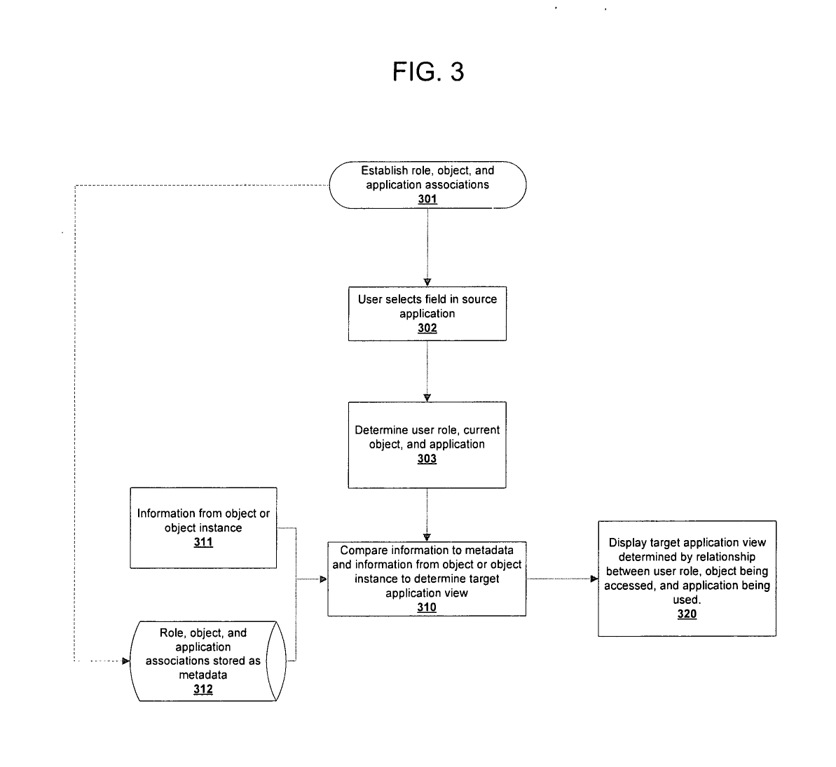

FIG. 3 shows an exemplary navigation process. A set of relationships between user roles, objects, and applications may be created at the time a system is designed 301. These relationships may be stored as business object metadata 312, or they may be stored in an external system such as a database. When a user selects a field in an application view 302, the system may determine a use context to access the business object 303. This information may then be compared 310 to the previously-created metadata 312, as well as information that may be sent by the business object being accessed by the user 311. Thus use context may be represented by a user's current role, the business object being accessed, and/or the application used. The user may then be directed to a target application view that is appropriate to any or all of the user's role, the business object being accessed, and the application being used 320. Other contextual data may also be used to determine the target view.

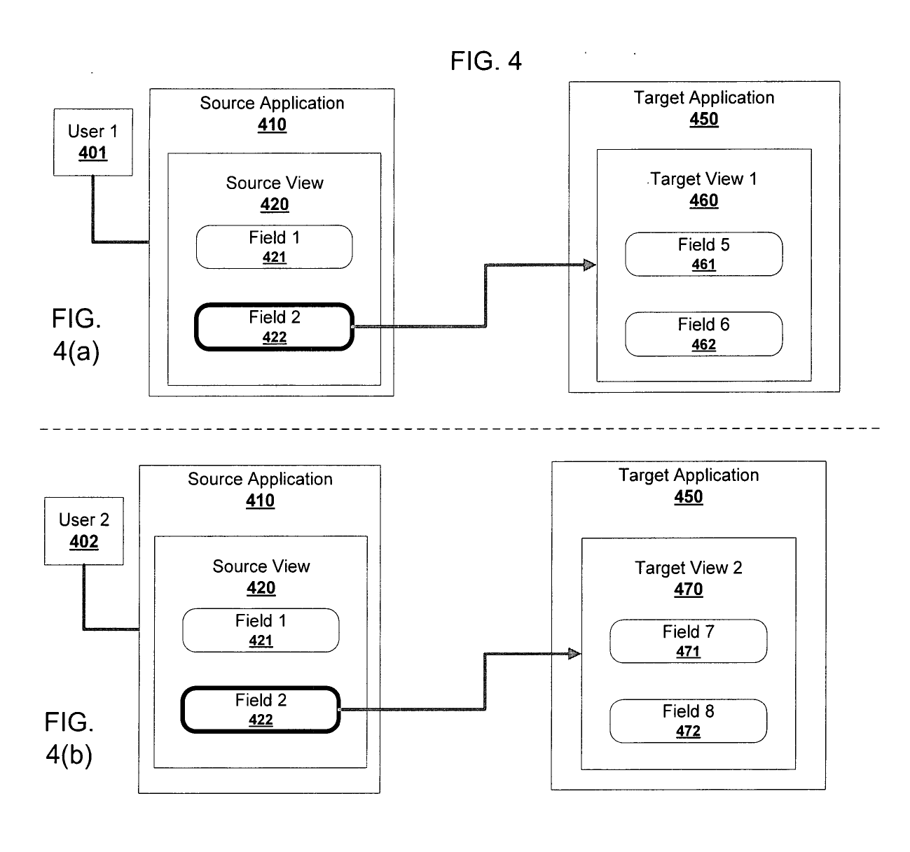

FIG. 4 shows an example of a user navigation according to an embodiment of the invention where the user may be directed to different target application views depending on the user's role. In the example shown in FIG. 4, two users having different roles may access the same business object instance within the same application. For example, one user 401 may be a user who has been given rights or privileges in the system allowing modification of customer orders, while another user 402 may have rights to view customer financial information. FIG. 4(a) shows a navigation by the first user 401 after selecting a navigation element 422. FIG. 4(b) shows a similar navigation by the second user 402 after selecting the same navigation element 422.

When each user 401 and 402 accesses a source application 410, the same navigation elements 421 and 422 may be displayed. The navigation elements may be hyperlinks, business object instances, or other appropriate fields. Each user may be directed to a different target application view 460 or 470 when a field 422 is selected. For example, the first user 401 may be directed to a target view 460 having fields 461 and 462 that allow for the user 401 to modify customer orders. The second user 402 may be directed to a different target view 460 in the target application 450, that displays fields 471 and 472 allowing the user 402 to view the same customer's financial information. Other rules may be used, such as rules placing users into groups based on their roles. For example, a user in a human resources department may be assigned different privileges and rights in the system, and therefore have a different role, than a user in a customer relations department. The system may also display different target views within the target application based on users' roles in conjunction with the source business object and application being accessed, as previously discussed. These relationships may be defined at the time the user navigation options are established by a user or system developer.

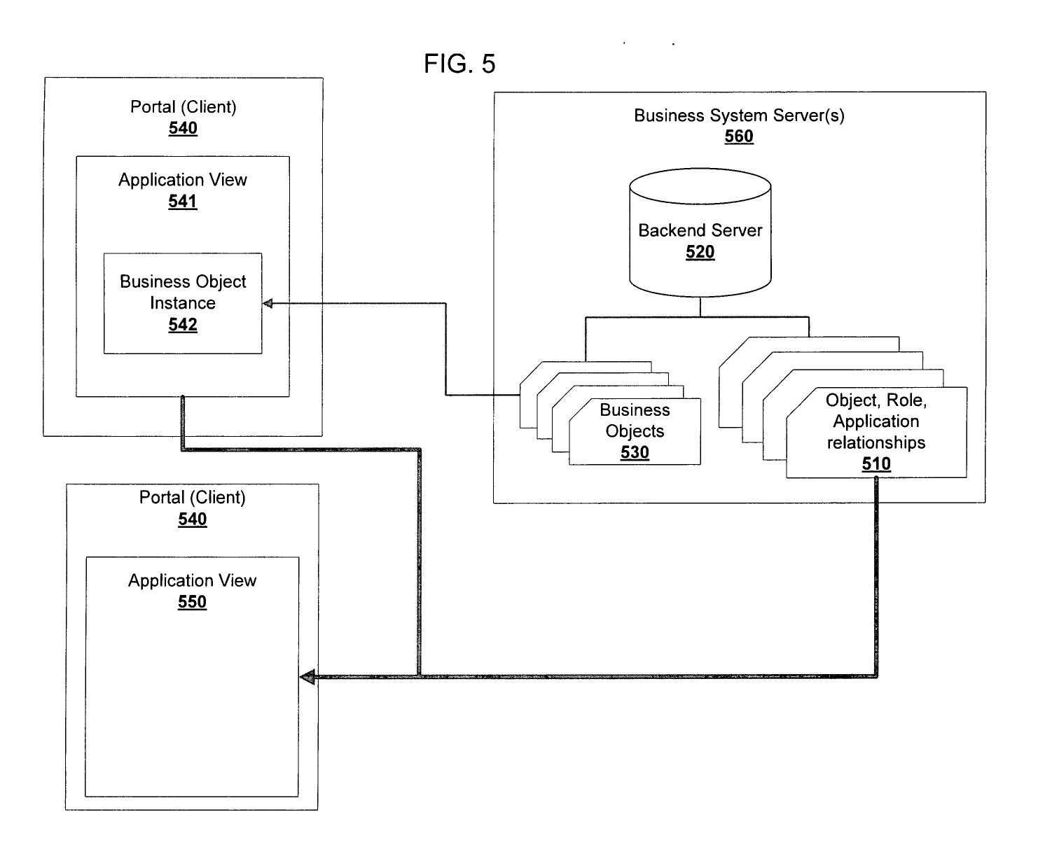

The relationships between roles, applications, and business objects may be stored as metadata in the business objects, or they may be stored separately, such as in a database. When a user selects a navigation element, a system according to an embodiment of the present invention may select a relationship from among the stored relationships that matches the user's role, the business object being accessed, and/or the application being used to access the business object. An example of such a system is illustrated in FIG. 5. A business system 560 may store multiple business objects 530, which may contain a set of relationships 510 describing target application views for pairings of user roles, applications, and business objects. Other contextual criteria may be used. The relationships 510 may be stored in metadata of the business objects 530, or they may be stored elsewhere in the business system 560 such as a database 520. A user may view one or more applications 541 via a portal 540. The portal 540 may reside on the user's client computer or application; the business system 560 may run on or contain one or more servers. Each application view may display instances of one or more business objects. Similarly, the application may display an instance of a single business object. Each business object or application may present navigation options to the user. For example, a business object displayed in an application may allow the user to select a navigation element such as a field displayed in the business object in order to view a different business object. When a user selects a navigation element, for example by selecting a field in a business object instance 542, the system may consult the relationships 510 stored in the system to determine an appropriate target for the navigation. The portal 540 may then display a view of an application 550 specified by the appropriate relationship. The relationships 510 may be previously defined by a user, for example when the navigation possibilities of the business system 560 are designed. The elements displayed in the target application view 550 may be created by the portal 540, or they may be transmitted to the portal by the business system 560.

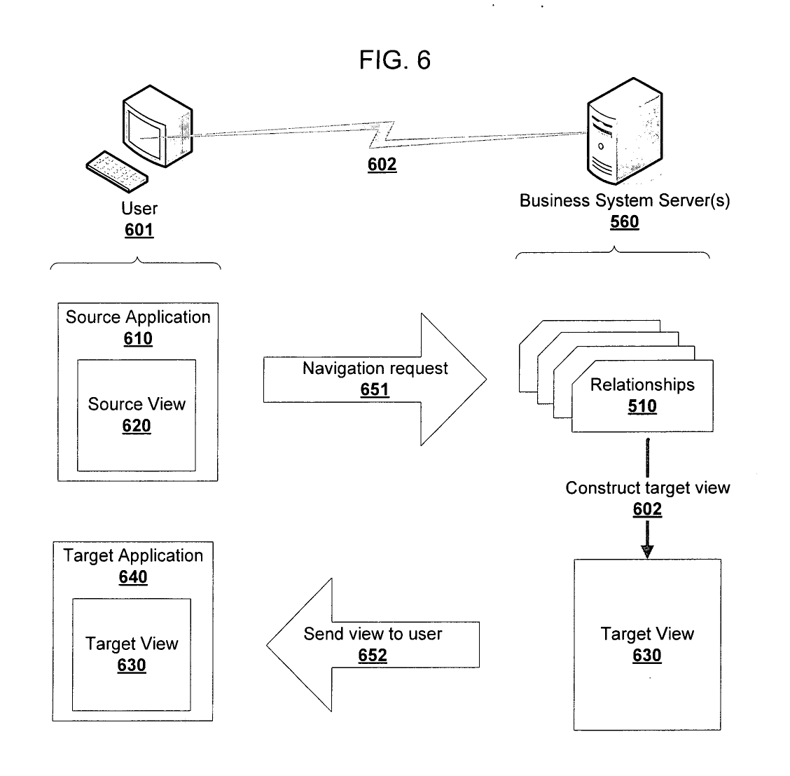

FIG. 6 shows an example system implementing object-based navigation according to an embodiment of the present invention. A user 601 may access one or more servers in the business system 560 via a communication network 602. The topology, architecture, and related protocols of the communication network 602 are immaterial to the present invention unless otherwise specified herein. A user may perform operations within the business system by accessing one or more applications 610. The applications may be stored and executed on the servers forming the business system 560, with an interface being transmitted to the user. For example, the application interfaces 610, 640 may be web pages that are transmitted to a web browser running on the user's client computer in response to actions and navigations performed by the user. In such an embodiment, the application views 620, 630 may be constructed as web pages by the business system server or servers and transmitted to the user. When a user selects a navigation element in a source application 610, a navigation request may be transmitted (651) to the business system 560. The business system may then compare contextual criteria, such as the user's role, a business object being accessed from the source view 620, and the source application 610 used, to a set of relationships 510. Based on these relationships, the business system 560 may construct (602) a target view 630 having business object instances, information, and navigation elements appropriate to the contextual criteria. The business system may transmit (652) this view to the user's client, where it may be displayed within the target application 640. The business system may indicate a specific target application for the target view to be displayed in, or the target view may be displayed within the source application 610 from which the user initiated the navigation. The target application 640 to which the user navigates may be defined by the navigation element selected by the user in the source application 610.

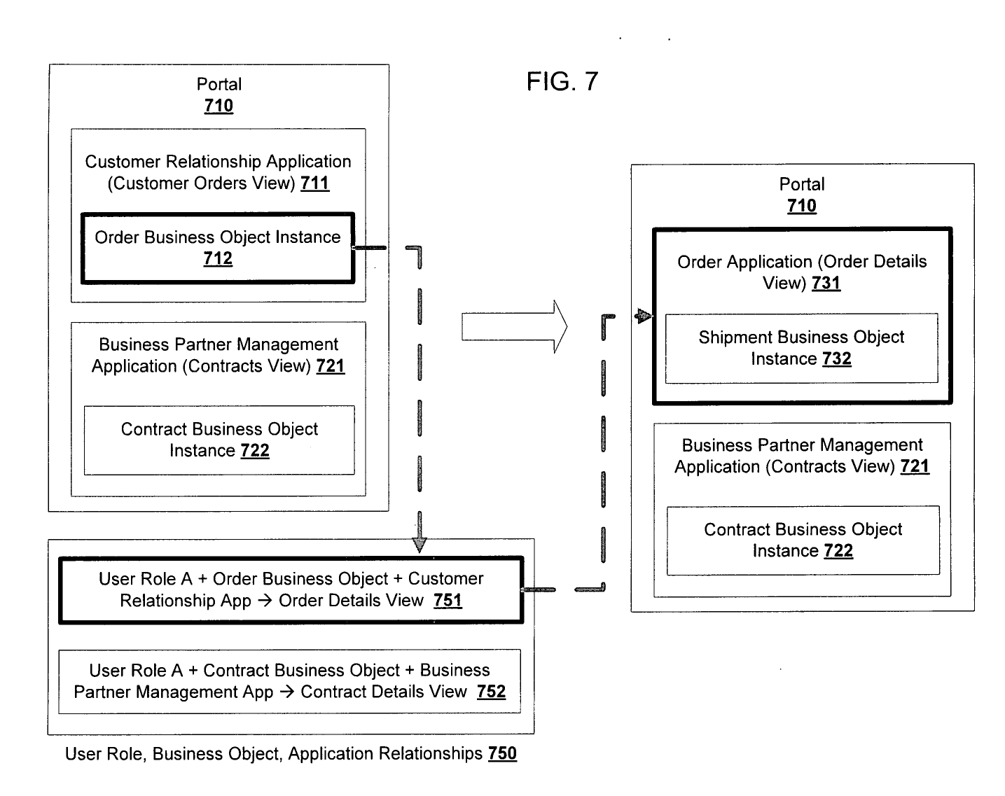

For purposes of illustration, a specific non-limiting example of a navigation according to an embodiment of the present invention is shown in FIG. 7. A user having a User Role “A” may access multiple applications 711, 721 via a portal 710. Each application may display navigation elements, system information, business object instances, and other data and structures. A specific view displayed by an application, such as a Customer Orders View of a Customer Relationship Application 711 and a Contracts View of a Business Partner Management Application 721, may display a specific set of business object instances and other data. When a user selects a navigation element, he may navigate to a different application. In FIG. 7, when the user selects the Order Business Object Instance 712, the Order Application 731 is opened in the portal 710. The selection of the Order Business Object Instance 712 may be made by selecting the instance directly, or it may be made by selecting a specific field or other navigation element within the instance. For example, if the portal 710 is a web browser that displays application interfaces 711 and 721 in different frames, the Order Business Object Instance 712 may be represented by a hyperlink displayed in the frame containing the Customer Orders View of the Customer Relationship Application 711. In order to determine which view of the Order Application to display, the system may consult pre-defined relationships 750.

The relationships 750 may specify combinations of user roles, business objects, and/or applications as previously described. For purposes of illustration, the example in FIG. 7 does not show all possible combinations of user roles, business objects, and applications. Thus relationships other than those shown, such as relationships that specify different target application views for different user roles, may be defined. A relationship 751 matching the user role, the business object accessed, and the application may be selected by the system in order to determine a view of the target application to display. In the example shown, the matching relationship indicates that a selection of the Order Business Object 712 from the Customer Relationship Application 711, by a user with a User Role A, should result in the Order Details View 731 being displayed. This view may be the view that a user or system developer previously indicated is most related to the selection made by the user. The target application displaying the specified target view 731 may be displayed in the portal 710 from which the user accessed the source application 711. For example, if the portal 710 is a web browser displaying application interfaces in frames, the Order Application 731 may be displayed in the frame that previously displayed the Customer Relationship Application 711. Similarly, the Order Application 731 may be loaded in a separate window of the browser. The target view may contain additional business object instances 732, other navigation elements, and other appropriate data.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A method for providing context-based user navigation, comprising:
in response to a user selection of a navigation element in a source business object displayed in a source application, comparing at least one of the user's role, the source application, and the source business object to a set of relationships between applications, user roles, and business objects specifying target application views;
if a relationship matching at least one the user's role, the source application, or the source business object specifies a target application view, opening the target application and displaying the target view.

2. The method of claim 1, wherein the relationships are stored in metadata of business objects.

3. The method of claim 1, wherein the relationships are defined by a user.

4. A method for providing context-based navigation, comprising:
in response to a user operation in a source application interface, comparing at least one of the user's role, the source application, and a source business object to a set of relationships specifying target application views;
if a relationship matching at least one of the user's role, the source application, and the source business object specifies a target application view, constructing the target application view; and
transmitting the target application view to the user.

5. A machine-readable medium containing program instructions for execution on a processor, which when executed by the processor cause the processor to perform:
in response to a user selection of a navigation element in a source business object displayed in a source application, comparing at least one of the user's role, the source application, and the source business object to a set of relationships between applications, user roles, and business objects specifying target application views;
if a relationship matching at least one of the user's role, the source application, or the source business object specifies a target application view, opening the target application and displaying the target view.

6. The machine-readable medium of claim 5, wherein the relationships are defined by a user.

7. The machine-readable medium of claim 6, wherein the relationships are stored in metadata of business objects.

8. A system comprising:
storage for a plurality of business objects;
a source application to display navigation elements and an instance of at least one of the plurality of business objects;
a target application having multiple views;
storage for data representing a plurality of user roles maintained for the system; and
storage for a set of relationships, each relationship defining a view of a target application for a combination of a source application, a business object, and a user role.

9. The system of claim 8, wherein the relationships are stored in metadata of the business objects.

10. A context aware navigation method for portal sessions, comprising, at a server:
receiving a resource request from a client representing user interactivity with a navigation element of a rendered page of information within a portal session,
determining a use context of the portal session,
generating a new portal page having a target application view based on the selected navigation element and the use context, and
transmitting the page to the client.

11. The method of claim 10, wherein the resource request explicitly defines the use context.

12. The method of claim 10, wherein the resource request is generic across different use contexts and use context data is maintained by the server from prior interaction with the client.

13. The method of claim 10, wherein the use context represents a user role defined for portal sessions.

14. The method of claim 10, wherein the use context represents a source application executing on the server for which the portal session is active.

15. The method of claim 10, wherein the use context represents a business object currently active within the portal session.
